(19) United States
(12) Patent Application Publication
(10) Pub. No.: US 2014/0338316 A1
(43) Pub. Date: Nov. 20, 2014

(54) REGENERATION CIRCUIT FOR HYDRAULIC MOTOR, CONSTRUCTION MACHINE INCLUDING REGENERATION CIRCUIT, AND METHOD OF CONTROLLING REGENERATION CIRCUIT

(71) Applicant: SUMITOMO HEAVY INDUSTRIES, LTD., Tokyo (JP)

(72) Inventor: Koichiro TSUKANE, Kanagawa (JP)

(73) Assignee: SUMITOMO HEAVY INDUSTRIES, LTD., Tokyo (JP)

(21) Appl. No.: 14/202,064

(22) Filed: Mar. 10, 2014

(30) Foreign Application Priority Data
May 20, 2013 (JP) 2013-106596

(51) Int. Cl. F15B 1/02

(52) U.S. Cl. CPC F15B 1/024
USPC 60/327; 60/325

(57) ABSTRACT

A regeneration circuit includes an oil collection passage that collects return oil from a hydraulic motor to which pressure oil discharged from a hydraulic pump is supplied, a regeneration system that recovers energy from the collected return oil, and an oil resupply passage that resupplies pressure oil from the regeneration system to the hydraulic motor. The regeneration system includes a pressure oil inflow part that converts pressure energy of the collected return oil into mechanical energy, a pressure oil outflow part that outputs low pressure oil with a pressure lower than a pressure of the collected return oil to the oil resupply passage when the pressure energy of the collected return oil is converted into the mechanical energy, and a regeneration part that accumulates the mechanical energy.

### CROSS-REFERENCE TO RELATED APPLICATIONS

The present application is based upon and claims the benefit of priority of Japanese Patent Application No. 2013-106596 filed on May 20, 2013, the entire contents of which are incorporated herein by reference.

### BACKGROUND OF THE INVENTION

1. Field of the Invention

An aspect of this disclosure relates to a regeneration circuit for a hydraulic motor, a construction machine including the regeneration circuit, and a method of controlling the regeneration circuit.

2. Description of the Related Art

There exists a device (which is hereafter referred to as a “hydraulic motor”) for rotating, for example, an output shaft using a hydraulic pressure. A hydraulic motor is driven by pressure energy of pressure oil supplied from a hydraulic pump. Such a hydraulic motor discharges the supplied pressure oil as return oil.

The discharged return oil has excess energy (pressure, flow rate, etc.). To use the excess energy of the return oil, a certain type of hydraulic motor is configured to recover (the energy from) the discharged return oil.

Also, there exists a hydraulic system (hydraulic circuit) that converts kinetic energy generated by a movement of a swing motor (hydraulic motor) into potential energy of pressure oil (i.e., regenerates energy), and reuses the potential energy to accelerate the swing motor.

### SUMMARY OF THE INVENTION

In an aspect of this disclosure, there is provided a regeneration circuit including an oil collection passage that collects return oil from a hydraulic motor to which pressure oil discharged from a hydraulic pump is supplied, a regeneration system that recovers energy from the collected return oil, and an oil resupply passage that resupplies pressure oil from the regeneration system to the hydraulic motor. The regeneration system includes a pressure oil inflow part that converts pressure energy of the collected return oil into mechanical energy, a pressure oil outflow part that outputs low pressure oil with a pressure lower than a pressure of the collected return oil to the oil resupply passage when the pressure energy of the collected return oil is converted into the mechanical energy, and a regeneration part that accumulates the mechanical energy.

### BRIEF DESCRIPTION OF THE DRAWINGS

FIG. 1 is a schematic circuit diagram illustrating an exemplary configuration of a regeneration circuit for a hydraulic motor;

FIGS. 2A and 2B are schematic diagrams illustrating exemplary configurations of a regeneration system;

FIGS. 3A through 3C are schematic diagrams illustrating exemplary configurations of a regeneration system;

FIG. 4 is a schematic circuit diagram illustrating another exemplary configuration of a regeneration circuit for a hydraulic motor; and

FIG. 5 is a drawing illustrating an exemplary construction machine.

### DESCRIPTION OF EMBODIMENTS

With the related-art hydraulic system described above, a constant flow of oil (operating oil) is necessary in the hydraulic motor during a regeneration process and therefore pressure oil is continuously supplied from a hydraulic pump into the hydraulic motor. Also with the related-art hydraulic system, during a regeneration process of the hydraulic motor, the pressure of pressure oil discharged from the hydraulic pump is reduced before the pressure oil is supplied into the hydraulic motor. Accordingly, with the related-art hydraulic system, energy is consumed to discharge the pressure oil from the hydraulic pump even during a regeneration process. Further, with the related-art hydraulic system, energy losses such as a pressure loss and a heat loss occur when the pressure of pressure oil discharged from the hydraulic pump is reduced.

An aspect of this disclosure makes it possible to solve or reduce one or more of the problems of the related art.

Embodiments of the present invention are described below with reference to the accompanying drawings. The same or corresponding reference numbers are assigned to the same or corresponding components throughout the accompanying drawings, and repeated descriptions of those components are omitted. The drawings are not intended to indicate the dimensional ratio among components. Actual dimensions of components may be determined based on the disclosure of the present application.

Below, a regeneration circuit for a hydraulic motor is used as an example to describe the embodiments of the present invention. However, the present invention may also be applied to any device or circuit for recovering (collecting or storing) excess energy of a machine, an apparatus, a device, a unit, a system, or so on that rotates, for example, an output shaft using a hydraulic pressure.

The embodiments of the present invention are described in the following order:

1. HYDRAULIC CIRCUIT ACCORDING TO EMBODIMENT

1-1 REGENERATION SYSTEM

1-2 REGENERATION PROCESS

2. HYDRAULIC CIRCUIT ACCORDING TO ANOTHER EMBODIMENT

3. CONSTRUCTION MACHINE

### <<1. Hydraulic Circuit According to Embodiment>>

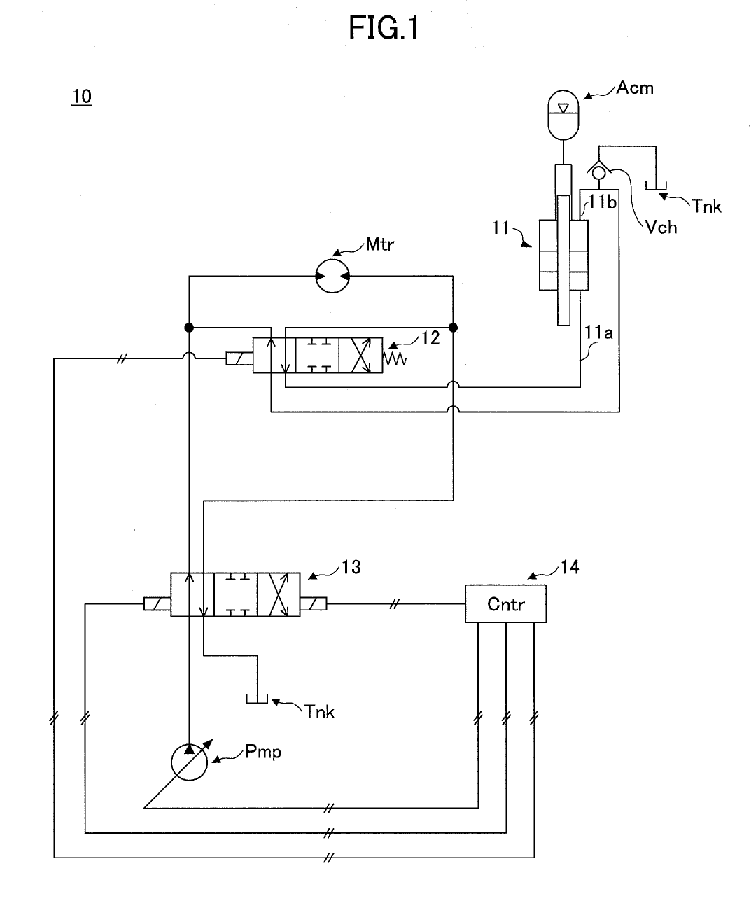

A hydraulic circuit 10 according to an embodiment of the present invention is described below with reference to FIG. 1. FIG. 1 is a schematic circuit diagram illustrating an exemplary configuration of the hydraulic circuit 10. In FIG. 1, lines with a symbol “//” indicate an electric control system, and lines without the symbol “//” indicate oil passages (passages of pressure oil).

FIG. 1 mainly illustrates oil passages for pressure oil discharged from a hydraulic pump Pmp and a regeneration circuit (a regeneration system 11, an oil collection passage 11a, and an oil resupply passage 11b), and other components (e.g., other hydraulic actuators such as a hydraulic cylinder and a hydraulic motor) are omitted.

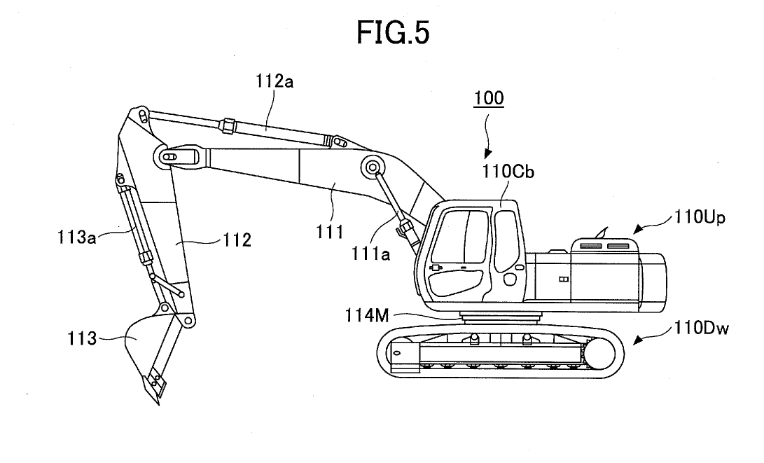

As illustrated by FIG. 1, the hydraulic circuit 10 may include the hydraulic pump Pmp that discharges pressure oil (operating oil), and a hydraulic motor Mtr to which the pressure oil discharged from the hydraulic pump Pmp is supplied. The hydraulic circuit 10 may also include an oil collection passage 11a for collecting return oil from the hydraulic motor Mtr, a regeneration system 11 for recovering energy from the collected return oil, and an oil resupply passage 11b for resupplying pressure oil from the regeneration system 11 to the hydraulic motor Mtr. The hydraulic circuit 10 may further include a control unit 14 for controlling operations of the entire hydraulic circuit 10. When the hydraulic circuit 10 is used for a construction machine (as exemplified by FIG. 5), the control unit 14 may be configured to control operations of the hydraulic circuit 10 according to the amount and direction of operation of a control lever by an operator.

The hydraulic pump Pmp discharges pressure oil (operating oil) to be supplied to the hydraulic motor Mtr (and other hydraulic actuators not shown). The hydraulic pump Pmp is mechanically connected to an output shaft of an engine of a power source (not shown) and is driven by the power source to discharge pressure oil. The control unit 14 controls the discharge rate (or flow rate) of the hydraulic pump Pmp. For example, when the hydraulic circuit 10 is provided in a construction machine, the control unit 14 controls the discharge rate (or the rotational angle of a regulator) of the hydraulic pump Pmp according to the amount of operation of a control lever by an operator.

The hydraulic motor Mtr rotates according to the pressure (hydraulic pressure) of supplied pressure oil. Examples of the hydraulic motor Mtr may include a gear motor, a vane motor, and a piston motor. In the present embodiment, pressure oil is supplied from the hydraulic pump Pmp to the hydraulic motor Mtr via a directional control valve 13 for switching rotational directions and rotational speeds of the hydraulic motor Mtr. The control unit 14 switches spool positions of the directional control valve 13. For example, when the hydraulic circuit 10 is provided in a construction machine, the control unit 14 controls the spool position of (or a remote control pressure to be input to) the directional control valve 13 according to the amount and direction of operation of a control lever by an operator.

In the hydraulic circuit 10 of the present embodiment, the oil collection passage 11a, the oil resupply passage 11b, and the regeneration system 11 constitute a regeneration circuit. However, in a broad sense, the entire hydraulic circuit 10 may also be referred to as a “regeneration circuit”.

The oil collection passage 11a is an oil passage for collecting return oil from the hydraulic motor Mtr. The oil collection passage 11a is connected via a hydraulic-motor-side switching valve 12 to the hydraulic motor Mtr. The hydraulic-motor-side switching valve 12 is switched based on the rotational direction of the hydraulic motor Mtr. The oil resupply passage 11b is an oil passage for resupplying pressure oil, which has a pressure lower than the pressure of the collected return oil, to the hydraulic motor Mtr. The oil resupply passage 11b is connected via the hydraulic-motor-side switching valve 12, which is switched based on the rotational direction of the hydraulic motor Mtr, to the hydraulic motor Mtr. The control unit 14 switches spool positions of the hydraulic-motor-side switching valve 12.

The regeneration system 11 recovers (collects or stores) energy from the collected return oil (i.e., regenerates energy). The regeneration system 11 includes a pressure oil inflow part that converts pressure energy of return oil, which is collected via the oil collection passage 11a, into mechanical energy; a pressure oil outflow part that outputs pressure oil (e.g., low pressure oil), which has a pressure lower than the pressure of the return oil, to the oil resupply passage 11b when the pressure energy of the return oil is converted into mechanical energy; and a regeneration part that stores the mechanical energy obtained by converting the pressure energy of the return oil. The pressure oil inflow part, the pressure oil outflow part, and the regeneration part (and an accumulator Acm, an operating oil tank Tnk, and a check valve Vch in FIG. 1) are described in more detail later in “1-1 REGENERATION SYSTEM”.

The control unit 14 controls the discharge rate (or flow rate) of the hydraulic pump Pmp, the hydraulic-motor-side switching valve 12, and the directional control valve 13. The control unit 14 may be implemented by, for example, an arithmetic processing unit including a central processing unit (CPU), a random access memory (RAM), and a read-only memory (ROM). Also, when the hydraulic circuit 10 is provided in a construction machine, the control unit 14 may be implemented by a controller of the construction machine.

The regeneration circuit (the control unit 14) of the present embodiment collects return oil (e.g., high-pressure oil) from the hydraulic motor Mtr via the oil collection passage 11a during a regeneration process for recovering kinetic energy of the hydraulic motor Mtr. Also, the regeneration circuit of the present embodiment causes the regeneration system 11 to recover energy from the collected return oil during the regeneration process for recovering kinetic energy of the hydraulic motor Mtr. Further, the regeneration circuit of the present embodiment resupplies return oil (e.g., low-pressure oil) via the oil resupply passage 11b to the hydraulic motor Mtr during the regeneration process for recovering kinetic energy of the hydraulic motor Mtr.

With the above configuration, the hydraulic circuit 10 (a regeneration circuit for a hydraulic motor) of the present embodiment makes it possible to reduce the discharge rate of pressure oil supplied from the hydraulic pump Pmp to the hydraulic motor Mtr during the regeneration process for recovering kinetic energy of the hydraulic motor Mtr and thereby makes it possible to reduce energy necessary to discharge pressure oil from the hydraulic pump Pmp. The above configuration of the hydraulic circuit 10 (a regeneration circuit for a hydraulic motor) of the present embodiment also eliminates the need to reduce the pressure of pressure oil discharged from the hydraulic pump Pmp and supply the pressure oil with the reduced pressure to the hydraulic motor Mtr during a regeneration process for recovering kinetic energy of the hydraulic motor Mtr. This in turn makes it possible to prevent energy losses such as a pressure loss and a heat loss that occur as a result of supplying (and reducing the pressure of) pressure oil from the hydraulic pump Pmp.

### <1-1 Regeneration System>

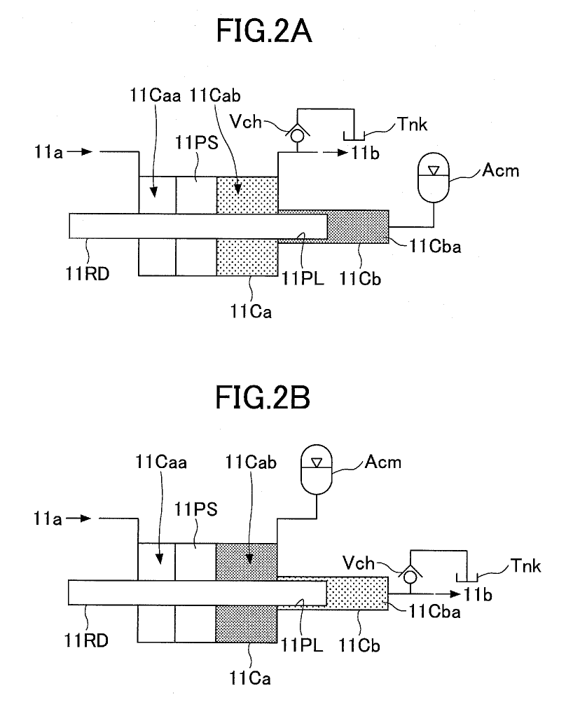

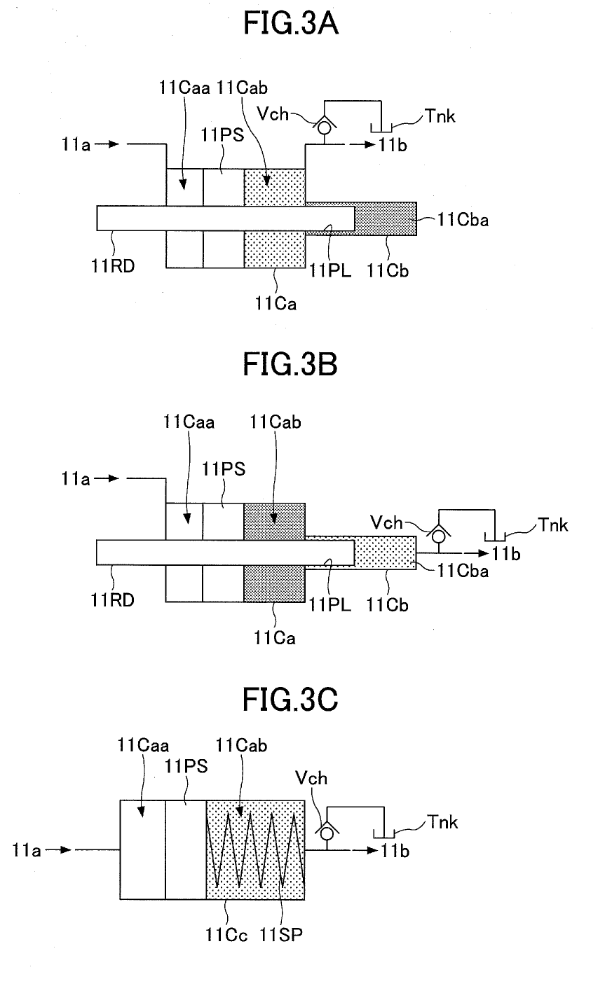

The hydraulic system 11 of the hydraulic circuit 10 according to the present embodiment is described below with reference to FIGS. 2A through 3C. FIGS. 2A and 2B are schematic diagrams illustrating an exemplary configuration of the regeneration system 11, and FIGS. 3A through 3C are schematic diagrams illustrating another exemplary configuration of the regeneration system 11. The configuration of the regeneration system 11 is not limited to those illustrated by FIGS. 2A and 2B and FIGS. 3A through 3C.

As illustrated by FIG. 2A, the regeneration system 11 includes a piston 11PS, a piston cylinder 11Ca, a plunger 11PL, and a plunger cylinder 11Cb. The regeneration system 11 includes multiple pressure chambers. The piston cylinder 11Ca is divided by the piston 11PS into two chambers: a cylinder chamber 11Caa and a cylinder chamber 11Cab. Also, a plunger cylinder chamber 11Cba is formed in the plunger cylinder 11Cb. The oil collection passage 11a is connected to the cylinder chamber Caa, and the oil resupply passage 11b is connected to the cylinder chamber 11Cab. Also, the operating oil tank Tnk and the check valve Vch are connected to the cylinder chamber Cab (the oil resupply passage 11b), and the accumulator Acm (e.g., pressure accumulator) is connected to the plunger cylinder chamber 11Cba.

In the exemplary configuration of FIG. 2A, the cylinder chamber 11Caa of the piston cylinder 11Ca is used as the pressure oil inflow part, the cylinder chamber 11Cab of the piston cylinder 11Ca is used as the pressure oil outflow part, and the plunger cylinder chamber 11Cba of the plunger cylinder 11Cb and the accumulator Acm are used as the regeneration part.

With the exemplary configuration of FIG. 2A, return oil collected via the oil collection passage 11a flows into the cylinder chamber 11Caa of the piston cylinder 11Ca. The regeneration system 11 converts the pressure energy of the return oil into mechanical energy of the piston 11PS.

When the pressure energy is converted into mechanical energy, the piston 11PS moves and causes oil (pressure oil with a pressure lower than the pressure of the return oil) in the cylinder chamber 11Cab to flow out into the oil resupply passage 11b. When the flow rate of the oil flowing out from the cylinder chamber 11Cab is less than the flow rate of the return oil (i.e., the flow rate of oil to be resupplied to the hydraulic motor Mtr), oil is drawn from the operating oil tank Tnk and supplied as pressure oil to the oil resupply passage 11b. Thus, the regeneration system 11 is configured such that oil (pressure oil) is automatically drawn (or suctioned) via the check valve Vch from the operating oil tank Tnk by a negative pressure in the oil resupply passage 11b (i.e., a suction pressure generated by an inertial force of the rotational movement of the hydraulic motor Mtr).

Also, when the plunger 11PL moves along with the movement of the piston 11PS, the pressure in the plunger cylinder chamber 11Cba increases. As a result, pressure oil is accumulated (or stored) in the accumulator Acm connected to the plunger cylinder chamber 11Cba. Thus, the regeneration system 11 can recover (or collect) pressure energy of return oil.

The accumulator Acm of the regeneration system 11 may be replaced with a power generator. Here, the power generator is a device that converts a driving force of an output shaft caused to rotate by supplied pressure oil into electric energy, and stores (or collects) the electric energy in a capacitor (e.g., a secondary battery).

Similarly to FIG. 2A, the regeneration system 11 of FIG. 2B includes a piston 11PS, a piston cylinder 11Ca (including a cylinder chamber 11Caa and a cylinder chamber 11Cab), a plunger 11PL, and a plunger cylinder 11Cb (including a plunger cylinder chamber 11Cba). In the configuration of FIG. 2B, however, the oil collection passage 11a is connected to the cylinder chamber Caa, and the accumulator Acm (e.g., a pressure accumulator) is connected to the cylinder chamber 11Cab. Also, the oil resupply passage 11b, the operating oil tank Tnk, and the check valve Vch are connected to the plunger cylinder chamber Cba.

In the exemplary configuration of FIG. 2B, the cylinder chamber 11Caa of the piston cylinder 11Ca is used as the pressure oil inflow part, the plunger cylinder chamber 11Cba of the plunger cylinder 11Cb is used as the pressure oil outflow part, and the cylinder chamber 11Cab of the piston cylinder 11Ca and the accumulator Acm are used as the regeneration part.

With the exemplary configuration of FIG. 2B, return oil collected via the oil collection passage 11a flows into the cylinder chamber 11Caa of the piston cylinder 11Ca. The regeneration system 11 converts the pressure energy of the return oil into mechanical energy of the piston 11PS.

When the pressure energy is converted into mechanical energy, the plunger 11PL moves along with the piston 11PS and causes oil (pressure oil with a pressure lower than the pressure of the return oil) in the plunger cylinder chamber 11Cba to flow out into the oil resupply passage 11b. When the flow rate of the oil flowing out from the plunger cylinder chamber 11Cba is less than the flow rate of the return oil. (i.e., the flow rate of oil to be resupplied to the hydraulic motor Mtr), similarly to the case of FIG. 2A, pressure oil is supplied from the operating oil tank Tnk to the oil resupply passage 11b.

Also, when the piston 11PS moves, the pressure in the cylinder chamber 11Cab increases. As a result, pressure oil is accumulated (or stored) in the accumulator Acm connected to the cylinder chamber 11Cab. Thus, the regeneration system 11 can recover (or collect) pressure energy of return oil.

Similarly to FIG. 2A, the regeneration system 11 of FIG. 3A includes a piston 11PS, a piston cylinder 11Ca (including a cylinder chamber 11Caa and a cylinder chamber 11Cab), a plunger 11PL, and a plunger cylinder 11Cb (including a plunger cylinder chamber 11Cba). Also in the configuration of FIG. 3A, the oil collection passage 11a is connected to the cylinder chamber Caa, and the oil resupply passage 11b, the operating oil tank Tnk, and the check valve Vch are connected to the cylinder chamber Cab. The regeneration system 11 of FIG. 3A uses the plunger cylinder chamber 11Cba as a piston accumulator. The piston accumulator may be implemented, for example, by filling the plunger cylinder chamber 11Cba with a gas.

In the exemplary configuration of FIG. 3A, the cylinder chamber 11Caa of the piston cylinder Ca is used as the pressure oil inflow part, the cylinder chamber 11Cab of the piston cylinder Ca is used as the pressure oil outflow part, and the plunger cylinder chamber 11Cba (piston accumulator) of the plunger cylinder 11Cb is used as the regeneration part.

With the exemplary configuration of FIG. 3A, return oil collected via the oil collection passage 11a flows into the cylinder chamber 11Caa of the piston cylinder Ca. The regeneration system 11 converts the pressure energy of the return oil into mechanical energy of the piston 11PS.

When the pressure energy is converted into mechanical energy, the piston 11PS moves and causes oil (pressure oil with a pressure lower than the pressure of the return oil) in the cylinder chamber 11Cab to flow out into the oil resupply passage 11b. When the flow rate of the oil flowing out from the cylinder chamber 11Cab is less than the flow rate of the return oil (i.e., the flow rate of oil to be resupplied to the hydraulic motor Mtr), similarly to the case of FIG. 2A, pressure oil is supplied from the operating oil tank Tnk to the oil resupply passage 11b.

Also, when the plunger 11PL moves along with the movement of the piston 11PS, the pressure in the plunger cylinder chamber 11Cba increases. As a result, pressure energy is accumulated (or stored) in the plunger cylinder chamber Cba. Thus, the regeneration system 11 can recover (or collect) pressure energy of return oil.

Similarly to FIG. 2A, the regeneration system 11 of FIG. 3B includes a piston 11PS, a piston cylinder 11Ca (including a cylinder chamber 11Caa and a cylinder chamber 11Cab), a plunger 11PL, and a plunger cylinder 11Cb (including a plunger cylinder chamber 11Cba). Also in the configuration of FIG. 3B, the oil collection passage 11a is connected to the cylinder chamber Caa, and the oil resupply passage 11b, the operating oil tank Tnk, and the check valve Vch are connected to the plunger cylinder chamber Cba. The regeneration system 11 of FIG. 3A uses the cylinder chamber 11Cab as a piston accumulator.

In the exemplary configuration of FIG. 3B, the cylinder chamber 11Caa of the piston cylinder 11Ca is used as the pressure oil inflow part, the plunger cylinder chamber 11Cba of the plunger cylinder 11Cb is used as the pressure oil outflow part, and the cylinder chamber 11Cab of the piston cylinder 11Ca is used as the regeneration part.

With the exemplary configuration of FIG. 3B, return oil collected via the oil collection passage 11a flows into the cylinder chamber 11Caa of the piston cylinder 11Ca. The regeneration system 11 converts the pressure energy of the return oil into mechanical energy of the piston 11PS.

When the pressure energy is converted into mechanical energy, the plunger 11PL moves along with the piston 11PS and causes oil (pressure oil with a pressure lower than the pressure of the return oil) in the plunger cylinder chamber 11Cba to flow out into the oil resupply passage 11b. When the flow rate of the oil flowing out from the plunger cylinder chamber 11Cba is less than the flow rate of the return oil (i.e., the flow rate of oil to be resupplied to the hydraulic motor Mtr), similarly to the case of FIG. 2A, pressure oil is supplied from the operating oil tank Tnk to the oil resupply passage 11b.

Also, when the piston 11PS moves, the pressure in the cylinder chamber 11Cab increases. As a result, pressure energy is accumulated (or stored) in the cylinder chamber Cab. Thus, the regeneration system 11 can recover (or collect) pressure energy of return oil.

The regeneration system 11 of FIG. 3C includes a piston 11PS, a piston cylinder 11Ca (including a cylinder chamber 11Caa and a cylinder chamber 11Cab), and a spring 11SP connected to the piston 11PS. In the configuration of FIG. 3C, the oil collection passage 11a is connected to the cylinder chamber Caa, and the oil resupply passage 11b, the operating oil tank Tnk, and the check valve Vch are connected to the cylinder chamber Cab. The regeneration system 11 of FIG. 3C uses elastic deformation (restoring force) of the spring 11SP as an accumulator (energy accumulating unit).

In the exemplary configuration of FIG. 3C, the cylinder chamber 11Caa of the piston cylinder Ca is used as the pressure oil inflow part, the cylinder chamber 11Cab of the piston cylinder Ca is used as the pressure oil outflow part, and the spring 11SP is used as the regeneration part.

With the exemplary configuration of FIG. 3C, return oil collected via the oil collection passage 11a flows into the cylinder chamber 11Caa of the piston cylinder 11Ca. The regeneration system 11 converts the pressure energy of the return oil into mechanical energy of the piston 11PS.

When the pressure energy is converted into mechanical energy, the piston 11PS moves and causes oil (pressure oil with a pressure lower than the pressure of the return oil) in the cylinder chamber 11Cab to flow out into the oil resupply passage 11b. When the flow rate of the oil flowing out from the cylinder chamber 11Cab is less than the flow rate of the return oil (i.e., the flow rate of oil to be resupplied to the hydraulic motor Mtr), similarly to the case of FIG. 2A, pressure oil is supplied from the operating oil tank Tnk to the oil resupply passage 11b.

With the configuration of FIG. 3C, the pressure energy of the return oil is accumulated by the spring 11SP that is elastically deformed by the movement of the piston 11PS. Thus, the regeneration system 11 can recover (or collect) pressure energy of return oil.

### <1-2 Regeneration Process>

An exemplary regeneration process (collecting return oil and resupplying pressure oil) of the regeneration circuit (the hydraulic circuit 10) according to the present embodiment is described below. However, the present invention is not limited to the regeneration process described below.

The regeneration circuit of the present embodiment recovers kinetic energy of the hydraulic motor Mtr (FIG. 1) that is supplied with pressure oil discharged from the hydraulic pump Pmp (FIG. 1). In a collection step, the regeneration circuit collects return oil from the hydraulic motor Mtr via the oil collection passage 11a (FIG. 1). Next, in a regeneration step, the regeneration circuit recovers energy from the collected return oil by using the regeneration system 11 (FIG. 1). In a resupply step, the regeneration circuit resupplies pressure oil via the oil resupply passage 11b to the hydraulic motor Mtr.

In the regeneration step, the regeneration system 11 converts the pressure energy of the collected return oil into mechanical energy and accumulates (or stores) the mechanical energy.

In the resupply step, when the pressure energy is converted into mechanical energy in the regeneration step, the regeneration system 11 resupplies pressure oil, which has a pressure lower than the pressure of the return oil, via the oil resupply passage 11b to the hydraulic motor Mtr.

Thus, the hydraulic circuit 10 of the present embodiment can recover (or collect) excess energy from return oil by using the regeneration circuit (the oil collection passage 11a, the oil resupply passage 11b, and the regeneration system 11) for the hydraulic motor Mtr, and can improve energy use efficiency. Also, compared with a configuration where pressure oil is supplied from the hydraulic pump Pmp to the hydraulic motor Mtr during a regeneration process, the configuration of the hydraulic circuit 10 of the present embodiment makes it possible to reduce energy losses. For example, compared with a configuration where the pressure of pressure oil discharged from the hydraulic pump Pmp is reduced to correct a difference (pressure difference) between the discharge pressure of the hydraulic pump Pmp and the pressure of pressure oil to be supplied to the hydraulic motor Mtr, the configuration of the hydraulic circuit 10 of the present embodiment can save energy that is a product of the pressure difference and the flow rate of pressure oil supplied to the hydraulic motor Mtr. Also, the hydraulic circuit 10 of the present embodiment can collect return oil and resupply pressure oil by using the regeneration system 11. This in turn makes it possible to simplify the configuration of a hydraulic circuit. In other words, the present embodiment makes it possible to reduce the size of a hydraulic circuit and provide a hydraulic circuit that is versatile and easily controllable.

Compared with a configuration where the hydraulic motor Mtr draws oil directly from an operating oil tank during a regeneration process, the configuration of the hydraulic circuit 10 of the present embodiment makes it possible to (automatically) supply pressure oil from the operating oil tank Tnk connected to the oil resupply passage 11b. This in turn makes it possible to reduce pressure losses that occur in an oil passage between the hydraulic motor Mtr and the operating oil tank.

Further, the configuration of the hydraulic circuit 10 of the present embodiment makes it possible to reduce the amount of pressure oil (automatically) supplied from the operating oil tank Tnk. Compared with a configuration where the hydraulic motor Mtr draws oil directly from an operating oil tank, the configuration of the present embodiment makes it possible to prevent the occurrence of cavitation.

### <<2. Hydraulic Circuit According to Another Embodiment>>

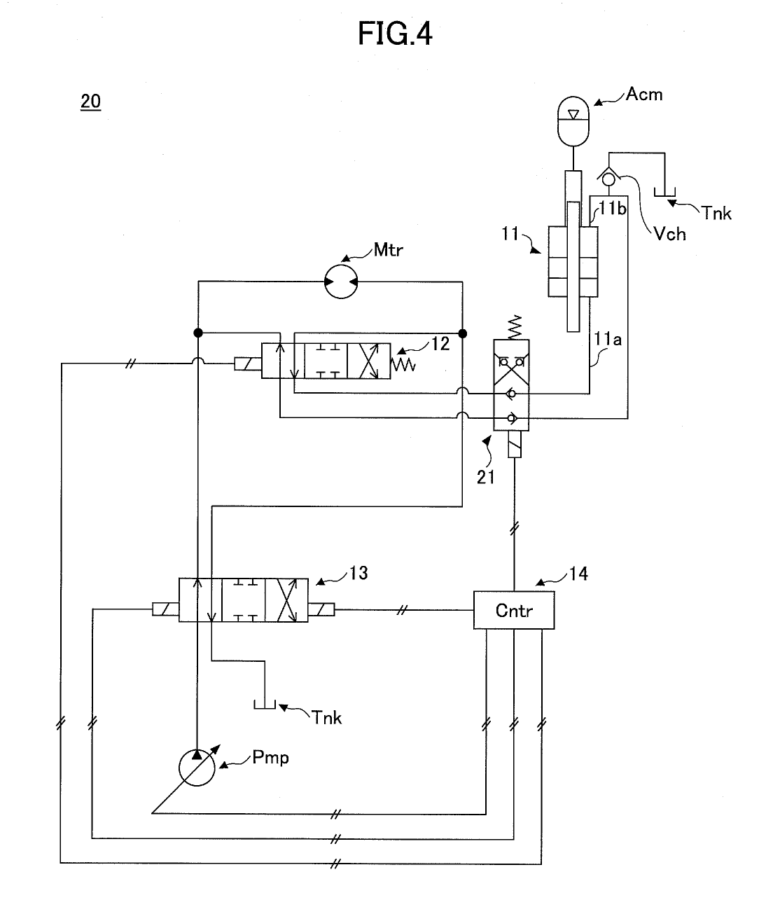

A hydraulic circuit 20 according to another embodiment is described below with reference to FIG. 4.

FIG. 4 is a schematic circuit diagram illustrating an exemplary configuration of the hydraulic circuit 20. In FIG. 4, lines with a symbol “//” indicate an electric control system, and lines without the symbol “//” indicate oil passages (passages of pressure oil).

As illustrated by FIG. 4, a regeneration circuit (the hydraulic circuit 20) of the present embodiment includes, in addition to the components of the hydraulic circuit 10 of the above embodiment, a regeneration-system-side switching valve 21 for switching pressure oil inflow and outflow directions (the pressure oil inflow part and the pressure oil outflow part) of the regeneration system 11. The regeneration-system-side switching valve 21 includes check valves.

Other components of the hydraulic circuit 20 are substantially the same as those of the hydraulic circuit 10 of the above embodiment, and therefore descriptions of those components are omitted here.

The regeneration-system-side switching valve 21 is disposed in the oil collection passage 11a located upstream of the regeneration system 11 and the oil resupply passage 11b located downstream of the regeneration system 11. The regeneration-system-side switching valve 21 switches a port (the pressure oil inflow part) of the regeneration system 11 into which return oil flows and a passage (the oil resupply passage 11b) through which pressure oil output from the regeneration system 11 flows. The control unit 14 controls spool positions of the regeneration-system-side switching valve 21. For example, the control unit 14 may be configured to control spool positions of the regeneration-system-side switching valve 21 based on operating states (e.g., a pressure accumulated state and a pressure released state) of the regeneration system 11.

With the regeneration-system-side switching valve 21, the regeneration circuit (the hydraulic circuit 20) of the present embodiment can control a process of collecting return oil and a process of resupplying pressure oil, which are performed by the regeneration system 11, based on operating states of the regeneration system 11. Also, the regeneration circuit (the hydraulic circuit 20) of the present embodiment provides substantially the same advantageous effects as the regeneration circuit (the hydraulic circuit 10) of the above embodiment.

### <3. Construction Machine>

A construction machine 100 including a regeneration circuit for a hydraulic motor is described below. The construction machine 100 is just an example of a machine for which a regeneration circuit of an embodiment of the present invention can be used. A regeneration circuit according to an embodiment of the present invention may also be used for any other machine, apparatus, device, circuit, unit, system, or so on that includes a hydraulic motor. Examples of construction machines for which a regeneration circuit of an embodiment of the present invention can be used may include a hydraulic shovel, a truck crane, a bulldozer, a wheel loader, a dump truck, a pile driver, a pile drawer, a water jet machine, mud water treatment equipment, a grout mixer, a deep foundation construction machine, and a boring machine.

An exemplary configuration of the construction machine 100 of the present embodiment is described below with reference to FIG. 5.

As illustrated by FIG. 5, the construction machine 100 includes an upper rotating body 110Up on which a cab (operator's compartment) 110Cb is mounted, and a lower traveling body 110Dw (which includes, for example, wheels) that enables the construction machine 100 to run. The construction machine 100 also includes, as attachments, a boom 111 whose base part is rotatably supported by the upper rotating body 110Up, an arm 112 rotatably attached to an end of the boom 111, and a bucket 113 rotatably attached to an end of the arm 112. The construction machine 100 further includes, as hydraulic actuators, a boom cylinder 111a for driving the boom 111, an arm cylinder 112a for driving the arm 112, a bucket cylinder 113a for driving the bucket 113, and a swing (or rotary) motor 114M (which may corresponds to the hydraulic motor Mtr in the above embodiments) for causing the upper rotating body 110Up to rotate or swing. Instead of the bucket 113, any other attachment (end attachment) may be attached to the arm 112.

In the construction machine 100 of the present embodiment, a hydraulic circuit (e.g., the hydraulic circuit 10 of FIG. 1 or the hydraulic circuit 20 of FIG. 4) supplies operating oil (pressure oil) to the boom cylinder 111a to cause the boom cylinder 111a to extend and contracts in the length direction. When the boom cylinder 111a extends and contracts, the boom 111 moves upward and downward in front of and above the cab 110Cb. The hydraulic circuit controls a boom direction control valve based on the amount (and direction) of operation of a control lever by an operator (driver or worker) in the cab 110Cb, to control the amount of operating oil to be supplied to the boom cylinder 111a. Thus, the construction machine 100 performs a task according to the amount of operation of the control lever by the operator.

Similarly to the boom 111, the arm 112 and the bucket 113 moves in front of and above the cab 110Cb according to the extension and contraction movements of the arm cylinder 112a and the bucket cylinder 113a. The hydraulic circuit controls an arm direction control valve and a bucket direction control valve to control the amount of operating oil to be supplied to the arm cylinder 112a and the bucket cylinder 113a.

The construction machine 100 runs (forward, backward, rightward, and leftward movements) using wheels of the lower traveling body 110Dw, and rotates (or swings) using the swing motor 114M. The traveling of the construction machine 100 is controlled, for example, by traveling direction control valves according to the amount of operation of the control lever by the operator in the cab 110Cb.

In the construction machine 100 of the present embodiment, during a regeneration process of the swing motor 114M (the hydraulic motor Mtr), a regeneration circuit (the regeneration system 11 and the oil collection passage 11a of FIG. 1 or 4) of the hydraulic circuit collects return oil (energy) of operating oil (pressure oil) supplied to the swing motor 114M. Also in the construction machine 100, the regeneration circuit (the regeneration system 11 and the oil collection passage 11a of FIG. 1 or 4) resupplies pressure oil to the swing motor 114M.

Thus, the regeneration system 11 of the regeneration circuit of the construction machine 100 can collect return oil with a high pressure from the swing motor 114M and recover energy from the collected return oil when the swing motor 114M (the hydraulic motor Mtr) and other hydraulic actuators (the boom cylinder 111a, the arm cylinder 112a, and/or the bucket cylinder 113a) are driven concurrently. During the concurrent operation of the swing motor 114M and the other hydraulic actuators, the regeneration system 11 also resupplies pressure oil with a low pressure via the oil resupply passage 11b to the swing motor 114M. On the other hand, the hydraulic pump Pmp supplies the other hydraulic actuators with pressure oil corresponding to their load pressures. The above configuration of the hydraulic circuit of the construction machine 100 eliminates the need to reduce the pressure of pressure oil discharged from the hydraulic pump Pmp and supply the pressure oil with the reduced pressure to the hydraulic motor Mtr during a regeneration process of the hydraulic motor Mtr. This in turn makes it possible to prevent energy losses such as a pressure loss and a heat loss that occur when pressure oil is supplied from the hydraulic pump Pmp to the swing motor 114M.

Further, the regeneration circuit of the construction machine 100 can improve use efficiency of energy (e.g., pressure oil discharged from the hydraulic pump Pmp) by collecting return oil and resupplying pressure oil as described in the above embodiments.

An aspect of this disclosure provides a regeneration circuit that recovers excess energy of a hydraulic motor, collects return oil from the hydraulic motor, and resupplies pressure oil with a pressure lower than the pressure of the return oil to the hydraulic motor. Another aspect of this disclosure provides a construction machine including the regeneration circuit, and a method of controlling the regeneration circuit.

A regeneration circuit for a hydraulic motor, a construction machine including the regeneration circuit, and a method of controlling the regeneration circuit are described above according to the embodiments of the present invention. However, the present invention is not limited to the specifically disclosed embodiments, and variations and modifications may be made without departing from the scope of the present invention.

What is claimed is:

1. A regeneration circuit, comprising:
an oil collection passage that collects return oil from a hydraulic motor to which pressure oil discharged from a hydraulic pump is supplied;
a regeneration system that recovers energy from the collected return oil; and
an oil resupply passage that resupplies pressure oil from the regeneration system to the hydraulic motor,
wherein the regeneration system includes
a pressure oil inflow part that converts pressure energy of the collected return oil into mechanical energy,
a pressure oil outflow part that outputs low pressure oil with a pressure lower than a pressure of the collected return oil to the oil resupply passage when the pressure energy of the collected return oil is converted into the mechanical energy, and
a regeneration part that accumulates the mechanical energy.

2. The regeneration circuit as claimed in claim 1, wherein the pressure oil outflow part resupplies the low pressure oil via the oil resupply passage to the hydraulic motor to reduce a discharge rate of the pressure oil from the hydraulic pump during a regeneration process for recovering kinetic energy of the hydraulic motor.

3. The regeneration circuit as claimed in claim 1, wherein
the regeneration system includes a piston, a piston cylinder, a plunger, and a plunger cylinder;
the piston cylinder is divided by the piston into a first cylinder chamber and a second cylinder chamber, and the plunger cylinder includes a plunger cylinder chamber; and
the pressure oil inflow part includes the first cylinder chamber, the pressure oil outflow part includes the second cylinder chamber, and the regeneration part includes the plunger cylinder chamber.

4. The regeneration circuit as claimed in claim 3, wherein the regeneration part further includes an accumulator that accumulates pressure oil generated by the mechanical energy.

5. The regeneration circuit as claimed in claim 1, wherein
the regeneration system includes a piston, a piston cylinder, a plunger, and a plunger cylinder;
the piston cylinder is divided by the piston into a first cylinder chamber and a second cylinder chamber, and the plunger cylinder includes a plunger cylinder chamber; and
the pressure oil inflow part includes the first cylinder chamber, the pressure oil outflow part includes the plunger cylinder chamber, and the regeneration part includes the second cylinder chamber.

6. The regeneration circuit as claimed in claim 5, wherein the regeneration part further includes an accumulator that accumulates pressure oil generated by the mechanical energy.

7. The regeneration circuit as claimed in claim 1, further comprising:
an operating oil tank and a check valve connected to the oil resupply passage,
wherein the operating oil tank supplies pressure oil via the check valve to the oil resupply passage.

8. The regeneration circuit as claimed in claim 1, wherein
the regeneration system includes a piston, a piston cylinder, and a spring connected to the piston;
the piston cylinder is divided by the piston into a first cylinder chamber and a second cylinder chamber; and
the pressure oil inflow part includes the first cylinder chamber, the pressure oil outflow part includes the second cylinder chamber, and the regeneration part includes the spring.

9. The regeneration circuit as claimed in claim 1, further comprising:
a hydraulic actuator to which the pressure oil discharged from the hydraulic pump is supplied,
wherein when the hydraulic motor and the hydraulic actuator are driven concurrently,
the regeneration system collects the return oil with a high pressure from the hydraulic motor, recovers the energy from the collected return oil, and supplies the low pressure oil via the oil resupply passage to the hydraulic motor, and
the hydraulic pump supplies the hydraulic actuator with pressure oil corresponding to a load pressure of the hydraulic actuator.

10. The regeneration circuit as claimed in claim 1, further comprising:
a hydraulic-motor-side switching valve that switches oil passages connecting the oil collection passage and the oil resupply passage to the hydraulic motor, based on a rotational direction of the hydraulic motor; and
a regeneration-system-side switching valve that switches the pressure oil inflow part and the pressure oil outflow part of the regeneration system.

11. A construction machine, comprising:
the regeneration circuit of claim 1.

12. A method of controlling a regeneration circuit, the method comprising:
collecting return oil via an oil collection passage of the regeneration circuit from a hydraulic motor to which pressure oil discharged from a hydraulic pump is supplied;
recovering energy from the collected return oil; and
resupplying pressure oil via an oil resupply passage of the regeneration circuit to the hydraulic motor,
wherein in the recovering, pressure energy of the collected return oil is converted into mechanical energy by a regeneration system of the regeneration circuit, and the mechanical energy is accumulated; and
wherein in the resupplying, low pressure oil with a pressure lower than a pressure of the collected return oil is resupplied by the regeneration system via the oil resupply passage to the hydraulic motor when the pressure energy of the collected return oil is converted into the mechanical energy.
